(19) United States
(12) Patent Application Publication
(10) Pub. No.: US 2026/0300099 A1
(43) Pub. Date: Oct. 1, 2026

(54) IMAGE FORMING APPARATUS AND BACKUP CONTROL METHOD THAT EACH ALLOW SETTING INFORMATION BACKED UP IN ADVANCE TO BE PREVENTED FROM BEING OVERWRITTEN WITH SETTING INFORMATION IN NEW STORAGE DEVICE

(71) Applicant: KYOCERA Document Solutions Inc., Osaka (JP)

(72) Inventor: Hideo Tanii, Osaka (JP)

(21) Appl. No.: 19/576,372

(22) Filed: Mar. 24, 2026

(30) Foreign Application Priority Data
Mar. 31, 2025 (JP) 2025-058058

(51) Int. Cl. G06F 11/1446

(52) U.S. Cl. CPC G06F 11/1448; G06F 11/1469

(57) ABSTRACT

An image forming apparatus includes a backup processing portion, a first determination processing portion, and a first prohibition processing portion. The backup processing portion backs up setting information stored in a non-volatile storage device. The first determination processing portion determines whether or not the storage device is in an initial state in a case where a timing of backing up the setting information arrives. The first prohibition processing portion prohibits the backup processing portion from backing up the setting information in a case where the first determination processing portion determines that the storage device is in the initial state.

### INCORPORATION BY REFERENCE

This application is based upon and claims the benefit of priority from the corresponding Japanese Patent Application No. 2025-058058 filed on Mar. 31, 2025, the entire contents of which are incorporated herein by reference.

### BACKGROUND

This disclosure relates to an image forming apparatus and a backup control method.

An image forming apparatus including a non-volatile storage device in which setting information is stored has been known. In addition, the image forming apparatus has been known that backs up the setting information stored in the storage device to an external storage device and allows, when the storage device is replaced, the setting information backed up in advance to be restored to the storage device after the replacement.

### SUMMARY

An image forming apparatus according to an aspect of this disclosure includes a backup processing portion, a first determination processing portion, and a first prohibition processing portion. The backup processing portion backs up setting information stored in a non-volatile storage device. The first determination processing portion determines whether or not the storage device is in an initial state in a case where a timing of backing up the setting information arrives. The first prohibition processing portion prohibits the backup processing portion from backing up the setting information in a case where the first determination processing portion determines that the storage device is in the initial state.

A backup control method according to another aspect of this disclosure is executed by an image forming apparatus and includes a backup step, a determination step, and a prohibition step. In the backup step, setting information stored in a non-volatile storage device is backed up. In the determination step, it is determined whether or not the storage device is in an initial state in a case where a timing of backing up the setting information arrives. In the prohibition step, the backup step is prohibited from backing up the setting information in a case where the determination step determines that the storage device is in the initial state.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming system including an image forming apparatus according to an embodiment of this disclosure.

FIG. 2 is a block diagram showing a configuration of the image forming apparatus according to the embodiment of this disclosure.

FIG. 3 is a flowchart showing an example of a backup control process that is executed by the image forming apparatus according to the embodiment of this disclosure.

FIG. 4 is a flowchart showing an example of a restoration control process that is executed by the image forming apparatus according to the embodiment of this disclosure.

### DETAILED DESCRIPTION

Hereinafter, an embodiment of this disclosure will be described with reference to the accompanying drawings. It is noted that the following embodiment is a specific example of this disclosure and does not limit the technical scope of this disclosure.

### Configuration of Image Forming System 100

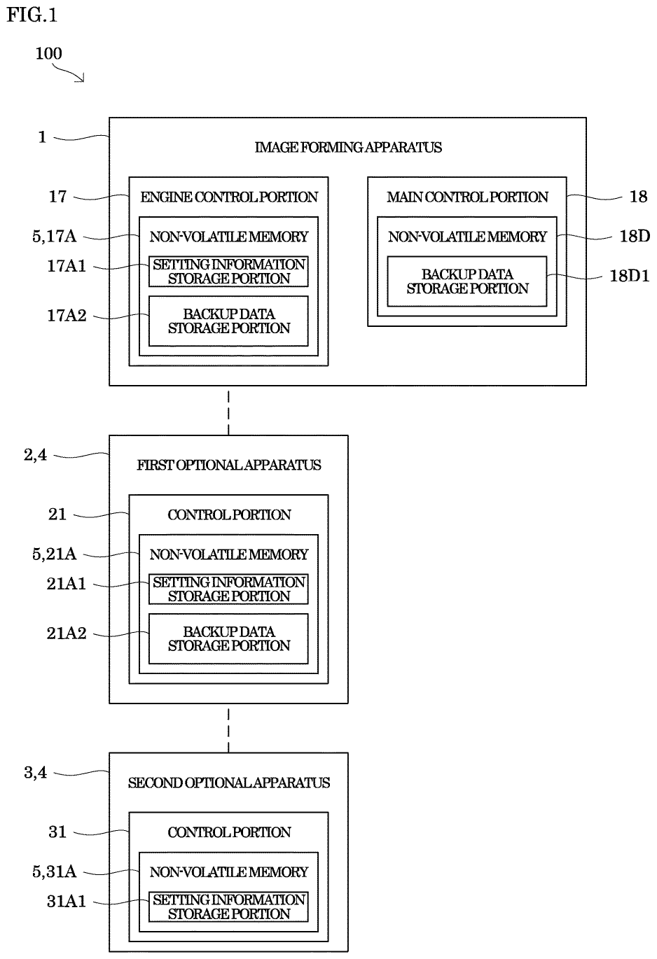

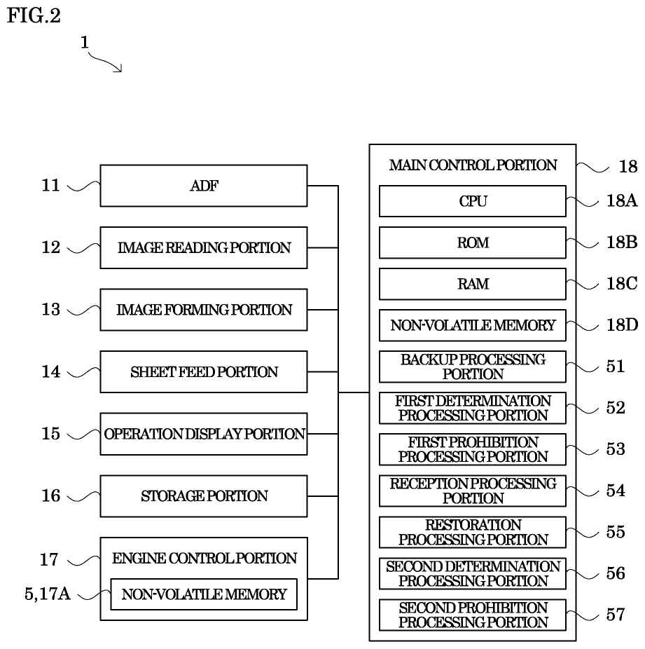

First, the configuration of an image forming system 100 including an image forming apparatus 1 according to the embodiment of this disclosure will be described with reference to FIGS. 1 and 2. It is noted that FIG. 1 shows a communication path between components of the image forming system 100 using a dashed line.

As shown in FIG. 1, the image forming system 100 includes the image forming apparatus 1 and two optional apparatuses 4 that are connected to the image forming apparatus 1.

One of the two optional apparatuses 4 is a first optional apparatus 2 that is communicably connected to the image forming apparatus 1. The other of the two optional apparatuses 4 is a second optional apparatus 3 that is communicably connected to the image forming apparatus 1 through the first optional apparatus 2. It is noted that the number of optional apparatuses 4 which are connected to the image forming apparatus 1 does not have to be limited to two.

The image forming apparatus 1 is a multifunction peripheral having a plurality of functions such as a facsimile function and a copy function along with a scan function of reading an image on a document sheet and a print function of forming an image on a sheet on the basis of image data. It is noted that the image forming apparatus 1 is not limited to the multifunction peripheral. It is favorable that the image forming apparatus 1 be an apparatus such as a printer, a facsimile apparatus, and a copier each having the print function.

As shown in FIG. 2, the image forming apparatus 1 includes an auto document feeder (ADF) 11, an image reading portion 12, an image forming portion 13, a sheet feed portion 14, an operation display portion 15, a storage portion 16, an engine control portion 17, and a main control portion 18.

The ADF 11 conveys a document sheet an image on which is read by the image reading portion 12. The ADF 11 includes a document sheet set portion, a plurality of conveying rollers, a document sheet holder, and a sheet discharge tray.

The image reading portion 12 implements the scan function. The image reading portion 12 includes a document sheet table, a light source, a plurality of mirrors, an optical lens, and a charge coupled device (CCD). The image reading portion 12 reads an image from a document sheet conveyed by the ADF 11 and outputs image data including the read image. In addition, the image reading portion 12 reads an image from a document sheet placed on the document sheet table and outputs image data including the read image.

The image forming portion 13 implements the print function. For example, the image forming portion 13 forms an image on a sheet by electrophotography. The image forming portion 13 includes a plurality of image forming units corresponding to a plurality of printing colors, a laser scanning unit, an intermediate transfer belt, a secondary transfer device, a fixing device, and a sheet discharge tray. The image forming portion 13 forms a color or monochrome image on the basis of image data output from the image reading portion 12. In addition, the image forming portion 13 forms a color or monochrome image on the basis of image data received from an external information processing apparatus. It is noted that the image forming portion 13 may form an image on a sheet in a scheme such as an inkjet scheme different from electrophotography.

The sheet feed portion 14 supplies a sheet to the image forming portion 13. The sheet feed portion 14 includes a sheet feed cassette and a plurality of conveying rollers. The image forming portion 13 forms an image on a sheet supplied from the sheet feed portion 14.

The operation display portion 15 is a user interface of the image forming system 100. The operation display portion 15 includes a display portion and an operation portion. The display portion displays various kinds of information in response to a control instruction from the main control portion 18. For example, the display portion is a display device such as a liquid-crystal display. The operation portion inputs various kinds of information to the main control portion 18 in response to an operation of a user. For example, the operation portion is an operation device including an operation key and a touch panel.

The storage portion 16 is a non-volatile storage device. For example, the storage portion 16 is a solid state drive (SSD) or a hard disk drive (HDD). It is noted that the storage portion 16 may be a non-volatile memory such as a flash memory.

The engine control portion 17 controls the ADF 11, the image reading portion 12, the image forming portion 13, and the sheet feed portion 14. For example, the engine control portion 17 includes an electronic circuit such as an integrated circuit (an ASIC or a DSP). As shown in FIG. 2, the engine control portion 17 includes a non-volatile memory 17A. The non-volatile memory 17A is a non-volatile storage device such as an EEPROM.

As shown in FIG. 1, the non-volatile memory 17A includes a setting information storage portion 17A1 that is used to store first setting information. The first setting information is used for the engine control portion 17 to control each of the portions of the image forming apparatus 1. Specifically, the first setting information includes various setting values related to functions of the image forming apparatus 1. The various setting values are set automatically or manually (by an operation of a user on the operation display portion 15). For example, the first setting information includes various setting values related to the scan function, various setting values related to the print function, various setting values related to the facsimile function, and various setting values related to the copy function. It is noted that the first setting information may include information indicating the number of operations of each of the portions of the image forming apparatus 1 like the number of operations of the image forming portion 13. In addition, it is favorable that the first setting information be rewritable information in information set or registered in the image forming apparatus 1 in advance.

The main control portion 18 centrally controls the image forming system 100. As shown in FIG. 2, the main control portion 18 includes a CPU 18A, a ROM 18B, a RAM 18C, and a non-volatile memory 18D. The CPU 18A is a processor that executes various calculation processes. The ROM 18B is a non-volatile storage device that stores in advance information about control programs or the like for causing the CPU 18A to execute the various processes. The RAM 18C is a volatile or non-volatile storage device that is used as a temporary storage memory (work area) for the various processes which are executed by the CPU 18A. The non-volatile memory 18D is a non-volatile storage device similar to the non-volatile memory 17A. The CPU 18A centrally controls the image forming system 100 by executing the various control programs stored in advance in the ROM 18B.

The first optional apparatus 2 is a function extension unit that extends a function of the image forming apparatus 1. Specifically, the first optional apparatus 2 is a post-processing apparatus that executes a first post-process defined in advance on a sheet on which an image has been formed. The sheet is output from the image forming apparatus 1. The first post-process is a staple process of binding a plurality of sheets together or another process. It is noted that the first optional apparatus 2 may be a sheet feed unit that supplies a sheet to the image forming portion 13 of the image forming apparatus 1 or another unit. In addition, the image forming system 100 may include the plurality of first optional apparatuses 2 each having a different function.

As shown in FIG. 1, the first optional apparatus 2 includes a control portion 21 that controls the first optional apparatus 2. For example, the control portion 21 includes an electronic circuit such as an integrated circuit (an ASIC or a DSP). As shown in FIG. 1, the control portion 21 includes a non-volatile memory 21A. The non-volatile memory 21A is a non-volatile storage device similar to the non-volatile memory 17A.

The first optional apparatus 2 holds second setting information. As shown in FIG. 1, the non-volatile memory 21A includes a setting information storage portion 21A1 that is used to store the second setting information. The second setting information is used for the control portion 21 to control each of the portions of the first optional apparatus 2. Specifically, the second setting information includes various setting values related to functions of the first optional apparatus 2. The various setting values are set automatically or manually (by an operation of a user on the operation display portion 15). For example, the second setting information includes various setting values related to a staple function. It is noted that the second setting information may include information indicating the number of operations of the first optional apparatus 2 like the number of executions of a staple process. In addition, it is favorable that the second setting information be rewritable information in information set or registered in the first optional apparatus 2 in advance.

The second optional apparatus 3 is a function extension unit that extends a function of the first optional apparatus 2. Specifically, the second optional apparatus 3 is a function extension unit capable of executing a second post-process different from the first post-process. The second post-process is a punch process of making a punch hole in a sheet, a folding process of folding a sheet, a bookbinding process of binding a plurality of sheets, a sorting process of sorting sheets, or the like. It is noted that the plurality of second optional apparatuses 3 each having a different function may be connected to the one first optional apparatus 2 in the image forming system 100. In addition, in the image forming system 100 including the plurality of first optional apparatuses 2, the one or more second optional apparatuses 3 may be connected to each of the first optional apparatuses 2.

As shown in FIG. 1, the second optional apparatus 3 includes a control portion 31 that controls the second optional apparatus 3. For example, the control portion 31 includes an electronic circuit such as an integrated circuit (an ASIC or a DSP). As shown in FIG. 1, the control portion 31 includes a non-volatile memory 31A. The non-volatile memory 31A is a non-volatile storage device similar to the non-volatile memory 17A.

The second optional apparatus 3 holds third setting information. As shown in FIG. 1, the non-volatile memory 31A includes a setting information storage portion 31A1 that is used to store the third setting information. The third setting information is used for the control portion 31 to control each of the portions of the second optional apparatus 3. Specifically, the third setting information includes various setting values related to functions of the second optional apparatus 3. The various setting values are set automatically or manually (by an operation of a user on the operation display portion 15). For example, the third setting information includes various setting values related to a punch function. It is noted that the third setting information may include information indicating the number of operations of the second optional apparatus 3 like the number of executions of a punch process. In addition, it is favorable that the third setting information be rewritable information in information set or registered in the second optional apparatus 3 in advance.

Hereinafter, the first setting information, the second setting information, and the third setting information will be generically referred to as “setting information” in some cases. In addition, the non-volatile memory 17A, the non-volatile memory 21A, and the non-volatile memory 31A that each store the setting information will be generically referred to as a “non-volatile memory 5” in some cases. The non-volatile memory 5 is an example of a non-volatile storage device according to this disclosure. In addition, the non-volatile memory 17A is an example of a first storage device according to this disclosure. In addition, the non-volatile memory 21A and the non-volatile memory 31A are examples of a second storage device according to this disclosure.

Incidentally, the image forming apparatus has been known that backs up the first setting information stored in the non-volatile memory 17A to an external storage device and allows, when the non-volatile memory 17A is replaced, the first setting information backed up in advance to be restored to the non-volatile memory 17A after the replacement.

Here, in a case where the timing of backing up the first setting information arrives immediately after the non-volatile memory 17A or a substrate on which the non-volatile memory 17A is implemented is replaced with a new non-volatile memory or a new substrate in the image forming apparatus, a problem that the first setting information backed up in advance is overwritten with the first setting information in the new non-volatile memory 17A arises.

In contrast, the image forming apparatus 1 according to the embodiment of this disclosure allows the setting information backed up in advance to be prevented from being overwritten with the setting information in the new non-volatile memory 5 as described below.

### Functional Configuration of Main Control Portion 18

Next, the functional configuration of the main control portion 18 will be described with reference to FIGS. 1 and 2.

As shown in FIG. 2, the main control portion 18 includes a backup processing portion 51, a first determination processing portion 52, a first prohibition processing portion 53, a reception processing portion 54, a restoration processing portion 55, a second determination processing portion 56, and a second prohibition processing portion 57.

Specifically, an operation control program for causing the CPU 18A to function as each of the processing portions described above is stored in advance in the ROM 18B of the main control portion 18. The CPU 18A then functions as each of the processing portions described above by executing the operation control program stored in the ROM 18B.

It is noted that the operation control program is recorded in a computer-readable recording medium such as a CD, a DVD, and a flash memory, and may be read from the recording medium and stored in a non-volatile storage device such as the storage portion 16. In addition, some or all of the processing portions included in the main control portion 18 may include an electronic circuit. In addition, the operation control program may be a program for causing a plurality of processors to function as the respective processing portions included in the main control portion 18.

The backup processing portion 51 backs up the setting information stored in the non-volatile memory 5.

For example, in a case where an execution timing defined in advance arrives, the backup processing portion 51 executes a third backup process of backing up the third setting information stored in the non-volatile memory 31A of the second optional apparatus 3.

In the third backup process, the third setting information stored in the non-volatile memory 31A of the second optional apparatus 3 is transferred to the first optional apparatus 2 communicably connected to the second optional apparatus 3. In addition, in the third backup process, the third setting information transferred from the second optional apparatus 3 is backed up in the first optional apparatus 2. Specifically, in the third backup process, the third setting information (backup data) transferred from the second optional apparatus 3 is stored in a backup data storage portion 21A2 (see FIG. 1) instead of existing data stored in the backup data storage portion 21A2. It is noted that the backup data storage portion 21A2 is a storage region provided in advance for a backup in the non-volatile memory 21A.

In addition, after the third backup process is executed, the backup processing portion 51 executes a second backup process of backing up the second setting information and the like stored in the non-volatile memory 21A of the first optional apparatus 2.

In the second backup process, the second setting information and the third setting information stored in the non-volatile memory 21A of the first optional apparatus 2 are transferred to the engine control portion 17. In addition, in the second backup process, the second setting information and the third setting information transferred from the first optional apparatus 2 are backed up in the engine control portion 17. Specifically, in the second backup process, both the second setting information and the third setting information (backup data) transferred from the first optional apparatus 2 are stored in a backup data storage portion 17A2 (see FIG. 1) instead of existing data stored in the backup data storage portion 17A2. It is noted that the backup data storage portion 17A2 is a storage region provided in advance for a backup in the non-volatile memory 17A.

In addition, after the second backup process is executed, the backup processing portion 51 executes a first backup process of backing up the first setting information and the like stored in the non-volatile memory 17A of the engine control portion 17.

In the first backup process, the first setting information, the second setting information, and the third setting information stored in the non-volatile memory 17A of the engine control portion 17 are transferred to the main control portion 18. In addition, in the first backup process, the first setting information, the second setting information, and the third setting information transferred from the engine control portion 17 are backed up in the main control portion 18. Specifically, in the first backup process, all the first setting information, the second setting information, and the third setting information (backup data) transferred from the engine control portion 17 are stored in a backup data storage portion 18D1 (see FIG. 1) instead of existing data stored in the backup data storage portion 18D1. It is noted that the backup data storage portion 18D1 is a storage region provided in advance for a backup in the non-volatile memory 18D.

In the second backup process, the second setting information in the first optional apparatus 2 that is acquired from the first optional apparatus 2 is stored in the backup data storage portion 17A2 of the engine control portion 17 and the backup data storage portion 18D1 of the main control portion 18. In addition, in the third backup process, the third setting information in the second optional apparatus 3 that is acquired from the second optional apparatus 3 is stored in the backup data storage portion 21A2 of the first optional apparatus 2 communicably connected to the second optional apparatus 3, the backup data storage portion 17A2 of the engine control portion 17, and the backup data storage portion 18D1 of the main control portion 18.

For example, the execution timing is a timing that arrives in a cycle set in advance. In addition, the execution timing may be the timing of receiving an operation of a user defined in advance on the operation display portion 15.

The first determination processing portion 52 determines whether or not the non-volatile memory 5 is in an initial state in a case where the timing of backing up the setting information arrives.

The initial state is a state in which, when an apparatus (the image forming apparatus 1 or the optional apparatus 4) including the non-volatile memory 5 is manufactured, the non-volatile memory 5 has initial data to be written therein. It is noted that the main control portion 18 may execute an initialization process of bringing the non-volatile memory 5 to the initial state in response to an operation of a user defined in advance on the operation display portion 15.

For example, state information to be used to determine whether or not the non-volatile memory 5 is in the initial state is stored in a specific storage region defined in advance in the non-volatile memory 5. When the apparatus including the non-volatile memory 5 is shipped from the factory, first information indicating that the non-volatile memory 5 is in the initial state is stored in the specific storage region in the non-volatile memory 5. The first information is overwritten with second information indicating that the non-volatile memory 5 is in a non-initial state at the timing at which information is written in the non-volatile memory 5. For example, the second information is the serial number of a substrate on which the non-volatile memory 5 is implemented. In this case, the first information is any information different from the serial number. Additionally, it is favorable that the second information be information which allows the non-volatile memory 5 to be identified.

For example, in a case where the execution timing arrives, the first determination processing portion 52 determines whether or not the non-volatile memory 31A is in the initial state on the basis of the state information stored in the specific storage region in the non-volatile memory 31A.

In addition, in a case where the execution timing arrives, the first determination processing portion 52 determines whether or not the non-volatile memory 21A is in the initial state on the basis of the state information stored in the specific storage region in the non-volatile memory 21A.

In addition, in a case where the execution timing arrives, the first determination processing portion 52 determines whether or not the non-volatile memory 17A is in the initial state on the basis of the state information stored in the specific storage region in the non-volatile memory 17A.

The first prohibition processing portion 53 prohibits the backup processing portion 51 from backing up the setting information in a case where the first determination processing portion 52 determines that the non-volatile memory 5 is in the initial state.

For example, in a case where the first determination processing portion 52 determines that any one or more of the non-volatile memory 31A, the non-volatile memory 21A, and the non-volatile memory 17A are in the initial state, the first prohibition processing portion 53 prohibits the backup processing portion 51 from executing the third backup process, the second backup process, and the first backup process.

For example, in a case where the first prohibition processing portion 53 prohibits the backup processing portion 51 from backing up the setting information, the first prohibition processing portion 53 causes the operation display portion 15 to display a first message indicating that.

The reception processing portion 54 receives a designation operation of designating any of the optional apparatus 4 connected to the image forming apparatus 1 and the engine control portion 17. The designation operation is an operation of designating a restoration target to which the setting information is restored.

For example, in a case where the operation display portion 15 receives a call operation defined in advance, the reception processing portion 54 causes the operation display portion 15 to display a designation operation reception screen that is used for the designation operation.

Here, in the designation operation reception screen, the respective restorable apparatuses of the optional apparatus 4 connected to the image forming apparatus 1 and the engine control portion 17 in which the setting information is backed up by the backup processing portion 51 are presented so as to be identifiable. In addition, the designation operation reception screen receives the designation operation of designating any of the presented restorable apparatuses.

The restoration processing portion 55 restores the setting information backed up in advance to the non-volatile memory 5.

Specifically, in a case where the reception processing portion 54 receives the designation operation, the restoration processing portion 55 restores the setting information backed up in advance by the backup processing portion 51 and corresponding to a designation apparatus designated by the designation operation to the designation apparatus.

For example, in a case where the designation apparatus is the engine control portion 17, the restoration processing portion 55 executes a first restoration process of restoring the first setting information.

In the first restoration process, the first setting information stored in the backup data storage portion 18D1 of the main control portion 18 is transferred to the engine control portion 17. In addition, in the first restoration process, the first setting information transferred from the main control portion 18 is restored in the engine control portion 17. That is, in the first restoration process, the first setting information (backup data) transferred from the main control portion 18 is stored in the setting information storage portion 17A1 instead of the existing first setting information stored in the setting information storage portion 17A1.

In addition, in a case where the designation apparatus is the first optional apparatus 2, the restoration processing portion 55 executes a second restoration process of restoring the second setting information corresponding to the first optional apparatus 2.

In the second restoration process, the second setting information corresponding to the designation apparatus among the second setting information stored in the backup data storage portion 17A2 of the engine control portion 17 is transferred to the designation apparatus. In addition, in the second restoration process, the second setting information transferred from the engine control portion 17 is restored in the designation apparatus. That is, in the second restoration process, the second setting information (backup data) transferred from the engine control portion 17 is stored in the setting information storage portion 21A1 instead of the existing second setting information stored in the setting information storage portion 21A1. This makes it possible to reduce the transfer time of the second setting information in comparison with the configuration in which the second setting information corresponding to the designation apparatus in the second setting information stored in the backup data storage portion 18D1 of the main control portion 18 is transferred to the designation apparatus.

In addition, in a case where the designation apparatus is the second optional apparatus 3, the restoration processing portion 55 executes a third restoration process of restoring the third setting information corresponding to the second optional apparatus 3.

In the third restoration process, the third setting information corresponding to the designation apparatus in the third setting information stored in the backup data storage portion 21A2 of the first optional apparatus 2 communicably connected to the designation apparatus is transferred to the designation apparatus. In addition, in the third restoration process, the third setting information transferred from the first optional apparatus 2 is restored in the designation apparatus. That is, in the third restoration process, the third setting information (backup data) transferred from the first optional apparatus 2 is stored in the setting information storage portion 31A1 instead of the existing third setting information stored in the setting information storage portion 31A1. This makes it possible to reduce the transfer time of the third setting information in comparison with the configuration in which the third setting information corresponding to the designation apparatus in the third setting information stored in the backup data storage portion 18D1 of the main control portion 18 or the backup data storage portion 17A2 of the engine control portion 17 is transferred to the designation apparatus.

Additionally, in a case where both the first optional apparatus 2 and the second optional apparatus 3 communicably connected to the first optional apparatus 2 are replaced at the same time in the image forming system 100, no data is stored in the backup data storage portion 21A2 of the first optional apparatus 2 after the replacement. In this case, it is favorable that the restoration processing portion 55 restore the third setting information stored in the backup data storage portion 17A2 of the engine control portion 17 to the second optional apparatus 3 after the replacement.

In a case where the timing of restoring the setting information arrives, the second determination processing portion 56 determines whether or not the non-volatile memory 5 is in the non-initial state and is a device different from the acquisition source of the setting information to be restored.

For example, in a case where the setting information is backed up, the image forming apparatus 1 executes an association process of associating the setting information and the second information stored in the specific storage region in the non-volatile memory 5 that is the acquisition source of the setting information.

The second determination processing portion 56 then determines whether or not the non-volatile memory 5 is in the non-initial state on the basis of the state information stored in the specific storage region in the non-volatile memory 5 of the designation apparatus. In addition, in a case where the second determination processing portion 56 determines that the non-volatile memory 5 of the designation apparatus is in the non-initial state, the second determination processing portion 56 determines whether or not the non-volatile memory 5 is a device different from the acquisition source of the setting information to be restored on the basis of the second information stored in the specific storage region in the non-volatile memory 5 and the second information associated with the setting information to be restored.

The second prohibition processing portion 57 prohibits the restoration processing portion 55 from restoring the setting information in a case where the second determination processing portion 56 determines that the non-volatile memory 5 is in the non-initial state and is a device different from the acquisition source of the setting information to be restored.

For example, in a case where the second prohibition processing portion 57 prohibits the restoration processing portion 55 from restoring the setting information, the second prohibition processing portion 57 causes the operation display portion 15 to display a second message indicating that.

### Backup Control Process

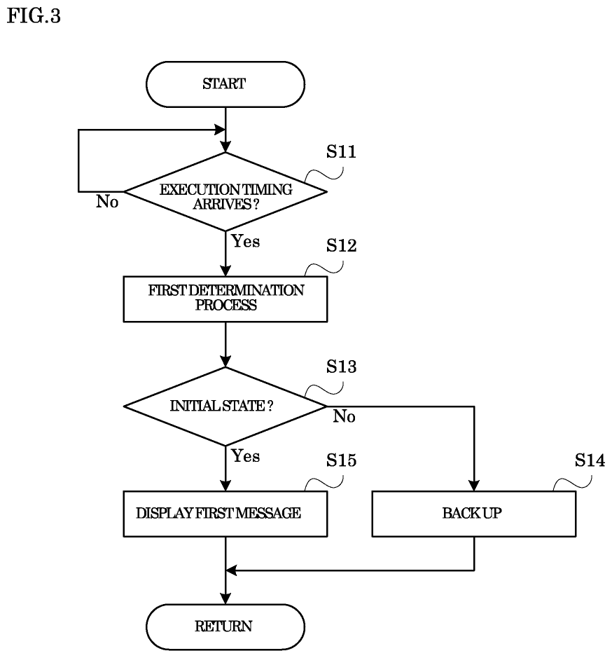

Hereinafter, a backup control method according to this disclosure will be described along with examples of procedures of a backup control process that is executed by the main control portion 18 in the image forming apparatus 1 with reference to FIG. 3. Here, steps S11, S12, . . . denote the numbers of processing procedures (steps) that are executed by the main control portion 18.

### Step S11

First, in step S11, the main control portion 18 determines whether or not the execution timing arrives.

Here, when the main control portion 18 determines that the execution timing arrives (Yes in S11), the main control portion 18 shifts the process to step S12. In addition, if the execution timing does not arrive (No in S11), the main control portion 18 waits for the arrival of the execution timing in step S11.

### Step S12

In step S12, the main control portion 18 executes, for each of the non-volatile memories 5, a first determination process of determining whether or not the non-volatile memory 5 is in the initial state. The process of step S12 is an example of a determination step according to this disclosure and is executed by the first determination processing portion 52 of the main control portion 18.

Specifically, in the first determination process, it is determined whether or not the non-volatile memory 31A is in the initial state on the basis of the state information stored in the specific storage region in the non-volatile memory 31A. In addition, in the first determination process, it is determined whether or not the non-volatile memory 21A is in the initial state on the basis of the state information stored in the specific storage region in the non-volatile memory 21A. In addition, in the first determination process, it is determined whether or not the non-volatile memory 17A is in the initial state on the basis of the state information stored in the specific storage region in the non-volatile memory 17A.

### Step S13

In step S13, the main control portion 18 switches a subsequent process depending on a result of the first determination process. Specifically, in a case where it is determined through the first determination process that any one or more of the non-volatile memory 31A, the non-volatile memory 21A, and the non-volatile memory 17A are in the initial state (Yes in S13), the main control portion 18 shifts the process to step S15. In addition, in a case where it is determined through the first determination process that any of the non-volatile memory 31A, the non-volatile memory 21A, and the non-volatile memory 17A are not in the initial state (No in S13), the main control portion 18 shifts the process to step S14.

### Step S14

In step S14, the main control portion 18 backs up the setting information. The process of step S14 is an example of a backup step according to this disclosure and is executed by the backup processing portion 51 of the main control portion 18.

Specifically, the main control portion 18 sequentially executes the third backup process, the second backup process, and the first backup process.

### Step S15

In step S15, the main control portion 18 causes the operation display portion 15 to display the first message instead of the process of step S14. The process of step S15 is an example of a prohibition step according to this disclosure and is executed by the first prohibition processing portion 53 of the main control portion 18.

### Restoration Control Process

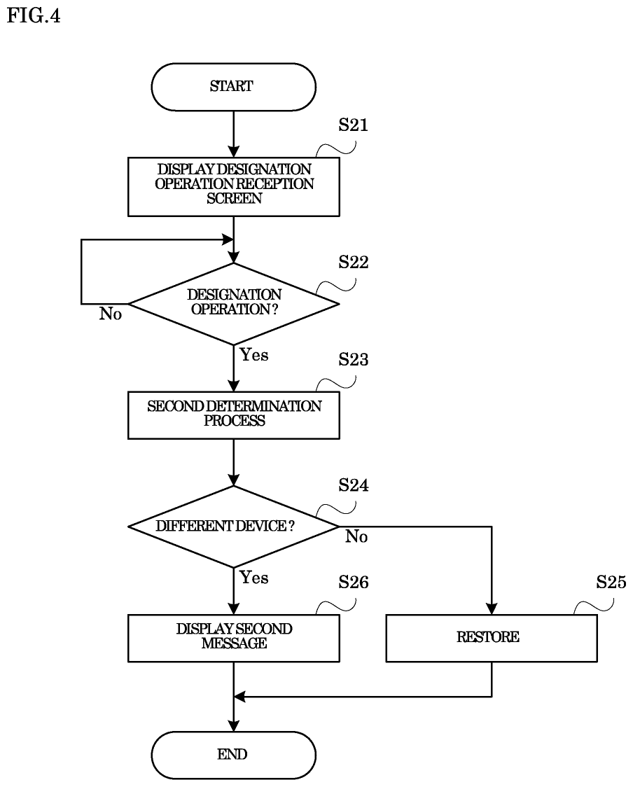

Next, examples of procedures of a restoration control process that is executed by the main control portion 18 in the image forming apparatus 1 will be described with reference to FIG. 4.

Additionally, in a case where the operation display portion 15 receives the call operation, the main control portion 18 executes the restoration control process.

### Step S21

First, in step S21, the main control portion 18 causes the operation display portion 15 to display the designation operation reception screen. The process of step S21 is executed by the reception processing portion 54 of the main control portion 18.

### Step S22

In step S22, the main control portion 18 determines whether or not the designation operation reception screen receives the designation operation.

Here, when the main control portion 18 determines that the designation operation is received (Yes in S22), the main control portion 18 shifts the process to step S23. In addition, if the designation operation is not received (No in S22), the main control portion 18 waits for the designation operation to be received in step S22.

### Step S23

In step S23, the main control portion 18 executes a second determination process of determining whether or not the non-volatile memory 5 of the designation apparatus designated by the designation operation is in the non-initial state and is a device different from the acquisition source of the setting information to be restored. The process of step S23 is executed by the second determination processing portion 56 of the main control portion 18.

Specifically, in the second determination process, it is determined whether or not the non-volatile memory 5 is in the non-initial state on the basis of the state information stored in the specific storage region in the non-volatile memory 5 of the designation apparatus. In addition, in a case where it is determined in the second determination process that the non-volatile memory 5 of the designation apparatus is in the non-initial state, it is determined whether or not the non-volatile memory 5 is a device different from the acquisition source of the setting information to be restored on the basis of the second information stored in the specific storage region in the non-volatile memory 5 and the second information associated with the setting information to be restored.

### Step S24

In step S24, the main control portion 18 switches a subsequent process depending on a result of the second determination process. Specifically, in a case where it is determined through the second determination process that the non-volatile memory 5 of the designation apparatus is in the non-initial state and is a device different from the acquisition source of the setting information to be restored (Yes in S24), the main control portion 18 shifts the process to step S26. In addition, in a case where it is not determined through the second determination process that the non-volatile memory 5 of the designation apparatus is in the non-initial state and is a device different from the acquisition source of the setting information to be restored (No in S24), the main control portion 18 shifts the process to step S25.

### Step S25

In step S25, the main control portion 18 restores the setting information in the designation apparatus that is backed up in advance to the non-volatile memory 5 of the designation apparatus. The process of step S25 is executed by the restoration processing portion 55 of the main control portion 18.

Specifically, in a case where the designation apparatus is the engine control portion 17, the main control portion 18 executes the first restoration process.

In addition, in a case where the designation apparatus is the first optional apparatus 2, the main control portion 18 executes the second restoration process.

In addition, in a case where the designation apparatus is the second optional apparatus 3, the main control portion 18 executes the third restoration process.

### Step S26

In step S26, the main control portion 18 causes the operation display portion 15 to display the second message instead of the process of step S25. The process of step S26 is executed by the second prohibition processing portion 57 of the main control portion 18.

In this way, in a case where the non-volatile memory 5 is in the initial state, the image forming apparatus 1 prohibits the setting information stored in the non-volatile memory 5 from being backed up. This makes it possible to prevent the setting information backed up in advance from being overwritten with the setting information in the new non-volatile memory 5.

In addition, in a case where the non-volatile memory 5 is in the non-initial state and is a device different from the acquisition source of the setting information to be restored, the image forming apparatus 1 prohibits the setting information from being restored to the non-volatile memory 5. This makes it possible to protect, in a case where the optional apparatus 4 is replaced by error, the setting information in the optional apparatus 4 after the replacement from deletion by restoration.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:
a backup processing portion configured to back up setting information stored in a non-volatile storage device;
a first determination processing portion configured to determine whether or not the storage device is in an initial state in a case where a timing of backing up the setting information arrives; and
a first prohibition processing portion configured to prohibit the backup processing portion from backing up the setting information in a case where the first determination processing portion determines that the storage device is in the initial state.

### Supplementary Note 2

The image forming apparatus according to Supplementary Note 1, including:
a restoration processing portion configured to restore the setting information backed up in advance to the storage device;
a second determination processing portion configured to determine whether or not the storage device is in a non-initial state and is a device different from an acquisition source of the setting information to be restored in a case where a timing of restoring the setting information arrives; and
a second prohibition processing portion configured to prohibit the restoration processing portion from restoring the setting information in a case where the second determination processing portion determines that the storage device is in the non-initial state and is the device different from the acquisition source of the setting information to be restored.
   supplementary Note 3

The image forming apparatus according to Supplementary Note 1 or 2, in which the storage device includes a first storage device and a second storage device, the first storage device being provided to the image forming apparatus, the second storage device being provided to an optional apparatus that is connected to the image forming apparatus.

supplementary Note 4

A backup control method that is executed by an image forming apparatus, the backup control method including:
a backup step of backing up setting information stored in a non-volatile storage device;
a determination step of determining whether or not the storage device is in an initial state in a case where a timing of backing up the setting information arrives; and
a prohibition step of prohibiting the backup step from backing up the setting information in a case where the determination step determines that the storage device is in the initial state.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a backup processing portion configured to back up setting information stored in a non-volatile storage device;
a first determination processing portion configured to determine whether or not the storage device is in an initial state in a case where a timing of backing up the setting information arrives; and
a first prohibition processing portion configured to prohibit the backup processing portion from backing up the setting information in a case where the first determination processing portion determines that the storage device is in the initial state.

2. The image forming apparatus according to claim 1, comprising:
a restoration processing portion configured to restore the setting information backed up in advance to the storage device;
a second determination processing portion configured to determine whether or not the storage device is in a non-initial state and is a device different from an acquisition source of the setting information to be restored in a case where a timing of restoring the setting information arrives; and
a second prohibition processing portion configured to prohibit the restoration processing portion from restoring the setting information in a case where the second determination processing portion determines that the storage device is in the non-initial state and is the device different from the acquisition source of the setting information to be restored.

3. The image forming apparatus according to claim 1, wherein the storage device includes a first storage device and a second storage device, the first storage device being provided to the image forming apparatus, the second storage device being provided to an optional apparatus that is connected to the image forming apparatus.

4. A backup control method that is executed by an image forming apparatus, the backup control method comprising:
a backup step of backing up setting information stored in a non-volatile storage device;
a determination step of determining whether or not the storage device is in an initial state in a case where a timing of backing up the setting information arrives; and
a prohibition step of prohibiting the backup step from backing up the setting information in a case where the determination step determines that the storage device is in the initial state.
